(19) United States
(12) Patent Application Publication
(10) Pub. No.: US 2015/0328955 A1
(43) Pub. Date: Nov. 19, 2015

(54) VENTILATION DEVICE FOR A VENTILATION, HEATING AND/OR AIR-CONDITIONING UNIT

(71) Applicant: Valeo Systemes Thermiques, Le Mesnil Saint Denis (FR)

(72) Inventors: Karen Chauvin, Le Pecq (FR); Xavier Goumain, Montigny Le Bretonneux (FR); Friedbald Kiel, Fontainebleau (FR)

(73) Assignee: VALEO SYSTEMES THERMIQUES, Le Mesnil Saint Denis (FR)

(21) Appl. No.: 14/653,487

(22) PCT Filed: Dec. 13, 2013
(86) PCT No.: PCT/EP2013/076513

§ 371 Date: Jun. 18, 2015

(30) Foreign Application Priority Data
Dec. 19, 2012 (FR) 1262304

(51) Int. Cl. B60H 1/24; B60H 1/32

(52) U.S. Cl. CPC B60H 1/24; B60H 1/32

(57) ABSTRACT

The invention relates to a ventilation device (1) for a ventilation unit of a motor vehicle passenger compartment, comprising: an impeller (4) that generates an air flow (11, 12) and can be driven by an electric motor; and a printed circuit board (15) having secured thereto at least one electronic component (19) that can release calories. The printed circuit board (15) comprises at least one through-hole (18) provided in a part (21) of the printed circuit board (15). The ventilation device (1) is configured such that the air flow (11, 12) generated by the impeller (4) moves along said part (21) of the printed circuit board (15).

The technical field of the present invention is that of ventilation devices intended to create a movement of a flow of air inside a ventilation, heating and/or air-conditioning unit for a motor vehicle.

Such a ventilation, heating and/or air-conditioning unit is conventionally formed by a housing, delimiting a channel within which an air flow moves. Heat exchangers are situated inside the housing in order to heat or cool the air flow dispatched into the passenger compartment of the motor vehicle. The air flow is set in circulation in the housing by a ventilation device, which is controlled by a control means and consists of a support accommodating an electric motor which drives an impeller in rotation. The support is mounted on the housing and the rotation of the impeller allows the air flow to be drawn in from outside the housing and dispatched to the inside of the housing. In this way a thermal exchange takes place between the air flow and the heat exchangers, so as to condition the vehicle passenger compartment thermally.

In the field of ventilation devices, it is known to install the control means directly adjacent to the electric motor which drives the impeller. Such a control means is therefore attached to the support. The control device manages the rotation speed of the impeller by acting on the motor voltage. This type of management system uses electronic components which are grouped onto a printed circuit board constituting the control means.

Some of these electronic components release heat. It is then known to add a radiator to the printed circuit board, the function of which is to dissipate the heat emitted by the electronic components. This radiator is applied to a face of the printed circuit board, with a thermally conductive mastic interposed between the radiator and the face of the printed circuit board so as to guarantee good heat conduction between said board and the radiator.

The abovementioned structure has several drawbacks. Firstly, such a radiator is a large part taking up considerable space in the ventilation device, which constitutes a constraint limiting the possibilities of reducing the size of this ventilation device. Also, the weight of the known ventilation device is further increased by the presence of the radiator, this being made of aluminum alloy. Finally, the radiator is a part which represents a non-negligible cost in the ventilation function.

The aim of the present invention is therefore to eliminate the abovementioned drawbacks primarily by arranging the ventilation device such that the large radiator of the prior art may be reduced in size or even omitted completely. Thus an air flow brought into circulation by the impeller is directed over a face of the circuit board, in particular over a zone in which at least one hole is produced, such a hole being for example metallized on its periphery or even filled so as to form a thermal drain.

The object of the invention is therefore a ventilation device for a ventilation unit of a passenger compartment of a motor vehicle, comprising a impeller generating an air flow and able to be driven by an electric motor, and a printed circuit board on which at least one electronic component able to release heat is attached, said printed circuit board comprising at least one through-hole provided in a part of said printed circuit board, the ventilation device being configured such that the air flow generated by the impeller passes over said part of the printed circuit board comprising at least one hole. Such a structure allows dissipation of the heat directly between the printed circuit board and the forced air flow, which avoids having recourse to a radiator. Thus the ventilation device according to the invention does not comprise a radiator.

The printed circuit board forms a control device able to control the electric motor. This control device is the means which determines the rotation speed of the impeller as a function of the demands made by the motor vehicle.

More precisely, the printed circuit board is delimited by a first face on which at least the electronic component able to release heat is attached, and by a second face opposite the first face relative to said printed circuit board, said second face forming at least said part of the printed circuit board over which the air flow passes. It is understood that the air flow comes into contact with this second face so as to capture the heat present on the printed circuit board.

Advantageously, a heat-conductive means extends into the hole. This heat-conductive means forms a thermal drain between the heat present on the first face, generated by the electronic component, and the air flow passing over the second face.

According to an exemplary embodiment, the heat-conductive means is formed by metallizing the hole. The wall of the printed circuit board delimiting the hole is thus covered by a metal layer which forms a thermal path.

According to a variant, an end of the heat-conductive means opens onto the second face so that the air flow passes over it. It is understood that the heat-conductive means extends from the first face to the second face so as to extend into the core of the air flow.

Further advantageously, the heat-conductive means is in contact with an electrically conductive track which extends over the first face at least as far as the electronic component. The conductive track, as well as conducting electrical current, is configured to drain the heat generated by the electronic component towards the heat-conductive means.

More precisely, an outer perimeter of the electronic component delimits a first region on the first face, the hole delimits a second region on the first face, the first region and the second region being separated by a distance not equal to zero. In other words, the electronic component is not arranged above the hole, the thermal drain between this electronic component and the hole is then provided by an electrically conductive track which runs at least between these two components.

Alternatively, an outer perimeter of the electronic component delimits a first region on the first face, the hole delimits a second region on the first face, the first region and the second region overlapping at least partly.

The regions mentioned in the two situations above correspond to a surface on the printed circuit board measured in the extension of the element concerned. A region thus forms a projection of the electronic component, the hole or the plurality of holes, perpendicular to the plane of the printed circuit board.

The ventilation device according to the invention in particular comprises a heat sink attached to the printed circuit board at the level of the hole, said heat sink opening from the second face so that the air flow passes over it.

Such a heat sink is attached to the second face, advantageously by brazing.

Alternatively or additionally, the heat sink is attached to the first face, also for example by brazing.

The heat sink comprises a head forming a stop against the printed circuit board.

Advantageously, the part of the printed circuit board over which the air flow passes carries at least a plurality of conductive tracks configured to limit a risk of electrical contact between two conductive tracks running over said part. Such a configuration is advantageous since the air flow passing over the printed circuit board may contain foreign bodies (impurities, particles, water) which could potentially lead to a short-circuit. This avoids the phenomenon of electrochemical migration linked to the presence of water, foreign bodies or a voltage between the tracks. The latter are then arranged on the second face on the part of the printed circuit board, so as to limit the risk of electrical contact between tracks because of this phenomenon. According to an exemplary embodiment, such a configuration results in a distance of more than 1.5 mm between two immediately adjacent tracks.

According to a characteristic of the invention, a wall is provided separating the printed circuit board into said part over which the air flow passes and a zone without said forced air flow. Such a wall may for example form part of a support constituting part of the ventilation device. An edge of this wall then rests against the second face of the printed circuit board so as to channel the air flow.

The part of the printed circuit board over which the air flow passes preferably carries no electronic components. As explained above, this part may comprise conductive tracks which run over the second face.

According to a characteristic of the invention, at least one electronic component is attached to said zone, in particular on the second face.

The invention finally covers a ventilation unit comprising a ventilation device according to any of the characteristics described above.

A first advantage of the invention lies in the possibility of designing a lighter ventilation device which is more compact and less costly than those of the prior art, while guaranteeing reliability compatible with use in the automotive sector and ensuring a function of cooling components which dissipate heat.

Further characteristics, advantages and details of the invention will arise more clearly from reading the description below which is given for information, and in relation to the attached drawings in which:

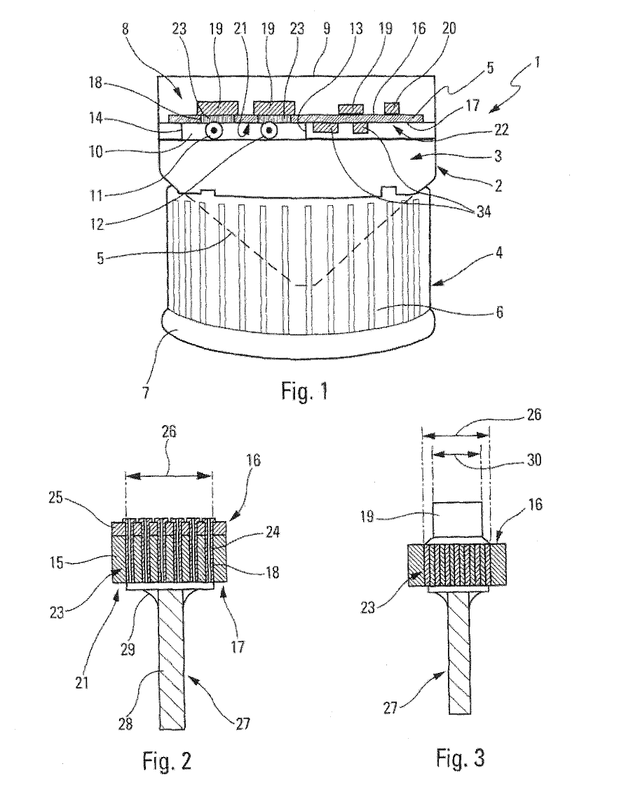

FIG. 1 is a diagrammatic view of the ventilation device according to the invention,

FIG. 2 is a cross section illustrating details of a first variant embodiment of the ventilation device according to the invention,

FIG. 3 is a cross section illustrating details of a second variant embodiment of the ventilation device according to the invention,

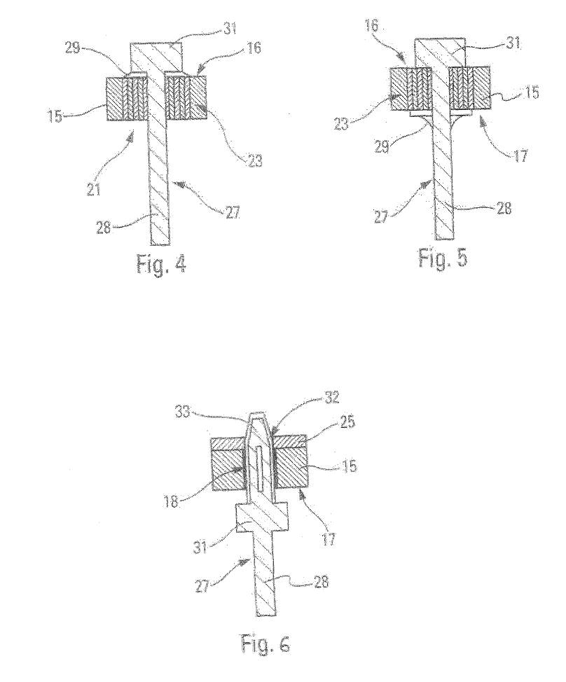

FIG. 4 is a cross section illustrating details of a third variant embodiment of the ventilation device according to the invention,

FIG. 5 is a cross section illustrating details of a fourth variant embodiment of the ventilation device according to the invention,

FIG. 6 is a cross section illustrating details of an eighth variant embodiment of the ventilation device according to the invention.

It must be noted that the figures depict the invention in detail for implementation of the invention, wherein said figures naturally may also serve for better definition of the invention where applicable.

FIG. 1 illustrates a ventilation device 1 according to the invention. Such a ventilation device comprises a support 2 within which an electric motor 3 is housed. According to an exemplary embodiment, such a motor is of the brush and commutator type, but the invention preferably concerns a brushless motor.

The electric motor 3 drives in rotation an impeller 4 comprising a disk 5 shown in dotted lines on this figure. This disk forms a means of driving the impeller since a shaft of the motor is linked to the disk 5. Such a disk is for example solid in the sense that its wall has no opening. According to another alternative, such a disk 5 has a plurality of orifices.

On the periphery of such a disk, a plurality of vanes 6 extends in a direction parallel to a extension direction of the motor shaft. The end of each vane is attached via a band 7. Such an impeller 4 thus forms a squirrel-cage impeller, otherwise known as a radial turbine.

At the opposite end of the impeller 4 relative to the electric motor 3 is a control device 8, a function of which is to control the rotation speed of the impeller by controlling the voltage or current sent to the electric motor 3. Said control device 8 is installed against the support 3 so it can be exposed to the air flow generated by the impeller 4, said control device being covered by a cover 9 so as to limit the ingress of foreign bodies into the portion of the ventilation device where the control device is installed.

The support 2 comprises a recess 10 in which the air flow brought into circulation by the impeller 4 may circulate, such an air flow being represented diagrammatically by two symbols marked 11 and 12. Said recess 10 is bordered laterally by at least one first wall 13 and advantageously by a second wall 14. It is understood that the air flow 11, 12 is channelled by the support 3 and at least the one or the other of the side walls marked 13 and 14.

This channel is also delimited by the control device 8. More precisely, the channel is delimited by a printed circuit board 15 constituting the control device 8. This printed circuit board 15 is formed by an electrically insulating substrate on which electrically conductive tracks are formed.

This printed circuit board 15 comprises a first face 16 and a second face 17 opposite the first face relative to the body of the printed circuit board. The portion of the printed circuit board 15 which closes the air flow circulation channel 11, 12, in combination with the first wall 13 and second wall 14, forms a part of said board in which at least one hole 18 is arranged, such a hole being a through-hole i.e. opening in the first face 16 and in the second face 17.

The first face 16 of the printed circuit board 15 carries electronic components, in particular power components 19 which dissipate heat and for which cooling is necessary in order to guarantee a reliability level compatible with use in the automotive sector. These components which release heat are for example transistors, in particular of the MOSFET type, but may also be condensers or shunts. The first face 16 may naturally receive other electronic components 20 which participate in the implementation of the control system or the protection of the electric motor.

The second face 17 of the printed circuit board is divided firstly into a part 21 of the printed circuit board 15 over which the air flow 11, 12 passes which is brought into circulation by the impeller 4, and secondly a zone 22 which is not exposed to the air flow generated by the impeller 4. The hole or holes 18 are arranged in the part 21 and are configured to receive a heat-conductive means.

The division into the part 21 of the printed circuit board and the zone 22 of the same board is achieved by the first wall 13 and advantageously by the second wall 14. It is understood that the air flow 11, 12 passes over the second face 17, which is level with the part of the printed circuit board which comprises at least one hole 18, so as to cool this part and by correlation to cool the electronic component 19 which release heat.

Such a part 21 of the printed circuit board forms a support for the conductive tracks. In other words, a plurality of conductive tracks runs over the second face over which the air flow passes, said tracks being arranged so as to limit the risk of short-circuit between two conductive tracks. Such an arrangement is for example a minimum distance separating the conductive tracks which run over the part over which the air flow passes. According to one embodiment, such a distance is for example at least 1.5 mm.

According to the invention, the zone 22 may comprise at least one electronic component 34 attached to the second face 17 at the zone 22. This zone also comprises a plurality of conductive tracks.

According to one embodiment, the hole or holes 18 comprise a heat-conductive means 23. According to the embodiment in FIG. 1, the heat-conductive means comprises thermal paths which may be filled with a heat-conductive material. In other words, the inner wall of the printed circuit board bordering the hole is metallized so as to form a thermal drain which extends from the first face 16 to the second face 17 of the printed circuit board. According to a variant, the central zone of the hole surrounded by the metallized part 24 may be free, forming a space. According to another alternative, the central zone of the hole may be filled with a material, for example the copper of one of the conductive tracks or the material used for brazing, or by coating.

One end of the metallized holes extends into the plane of the second face, and therefore the air flow 11, 12 passes over this. Alternatively, a metallized part 24 of the holes 18 may protrude beyond the plane of the second face 17 so as to extend into the air flow 11, 12. In both cases mentioned above, the metallized wall or walls form a thermal drain which conducts the heat generated by the electronic component 19 towards the air flow so as to be dissipated therein.

According to a first variant of the invention shown in FIG. 2, the heat-conductive means 23 is an assembly of thermal paths formed by the metallized holes 18, preferably filled with a heat-conductive material. In the example of FIG. 2, a plurality of holes 18 is provided, all of which have a metallized wall.

The metallized part 24 of the hole 18 is for example contained in the thickness of the printed circuit board 15, and is connected on the side of the first face 16 to a conductive track 25 which runs over the first face 16. According to this first variant, the electronic component which releases heat is not installed directly at the holes 18. On the contrary, this is remote from the holes, and the electrically conductive track 25, as well as conducting electricity, drains the heat from the electronic component towards the metallized part or parts 24 of the holes 18. It is understood here that an outer perimeter of the electronic component delimits a first region (not visible on the figure) on the first face 16, while the hole or plurality of holes 18 containing the heat-conductive means 23 delimits a second region 26 on the first face 16, the first region and the second region 26 being separated by a distance not equal to zero. The first region is an area of the first face 16 delimited by a projection of the electronic component perpendicular to the plane of the printed circuit board. The second region 26 is an area of the first face 16 occupied by the hole 18. In the case of a plurality of holes 18, the second region 26 is delimited by a periphery surrounding the plurality of holes 18.

Opposite the electrically conductive track 25, the metallized part 24 of the holes 18 terminates in the plane of the second face 17, and a heat sink 27 is attached to the board below the heat-conductive means 23, said heat sink starting from the second face 17 and terminating in the recess 10 delimiting the channel in which the air flow circulates. Said heat sink 27 is formed by a bar 28 fixed by a brazed joint 29 to the second face 17 at the level of the heat-conductive means 23, i.e. at least at the level of the second region 26.

To simplify FIGS. 3 to 5, the metallized part 24 and the holes 18 have been shown symbolically. It is nonetheless clear that the technical content of the embodiment described above and illustrated in FIG. 2 may be transposed to any of the embodiments illustrated in FIGS. 3 to 5, in particular in relation to the structure of the heat-conductive means 23.

FIG. 3 shows a second variant of the embodiment similar to that shown on FIG. 2. The differences will be described below and reference should be made to the description of FIG. 2 for identical elements.

One difference lies in the positioning of the electronic component 19 which is able to release heat. Whereas on FIG. 2 such a component is spaced from the hole or holes, the electronic component 19 is here fixed, in particular by brazing, to the first face 16 at the level of the plurality of holes 18 and advantageously at the level of the heat-conductive means 23. In other words, an outer perimeter of the electronic component 19 delimits the first region, here marked 30, on the first face 16. This first region 30 overlaps the second region 26 delimiting the periphery surrounding the plurality of holes 18. The invention covers the cases shown in this figure where the first region 30 is completely superimposed on the second region 26, but also covers the case where the first region 30 is only partly superimposed on the second region 26. In other words, the invention includes the situation where the electronic component 19 is arranged completely above the plurality of holes 18, but also covers the case where the electronic component 19 only partially overlaps the plurality of holes 18. The variant of this figure also comprises a heat sink 27, for example identical to that in FIG. 2.

The third variant of the invention is shown in FIG. 4. The part 21 of the printed circuit board 15 receives a heat-conductive means 23 identical to that of FIGS. 2 and 3. However the heat sink 27 takes a different form. In fact this passes through the printed circuit board 15 from one side to the other, at the level of the heat-conductive means 23, for example in the middle thereof. The bar 28 then has a first free end which opens into the air flow and a second end capped by a head 31, preferably formed integrally with the bar 28. The head 31 forms a flat surface which is fixed to the first face 16 by a brazed joint 29 at the level of the heat-conductive means 23.

The variant in FIG. 5 is similar to that in FIG. 4. The difference will be explained below and reference is made to the description of FIG. 4 for identical elements. The difference lies in the method of fixing the heat sink 27 to the heat-conductive means 23.

The heat sink 27 comprises a bar 28 capped by a head 31, identical to the variant in FIG. 4. The head 31 is not brazed to the heat-conductive means 23 at the level of the first face 16. The heat sink 27 then rests by its head 31 on a first end of the conductive means 23 and is attached thereto via a brazed joint 29 produced at the second face 17.

The third variant (FIG. 4) and the fourth variant (FIG. 5) of the invention use a heat sink 27 with a head 31, the latter protruding—or in other words extending—beyond the plane of the first face 16 between the electronic components attached to the first face 16. As well as the heat-conductive means, the head helps capture the heat generated by the electronic components in order to drain this towards the bar 28, over which the air flow passes when set in motion by the impeller.

FIG. 6 shows another variant of the invention. The heat sink 27 comprises its bar 28 with the head 31, here intended to form a stop against the second face 17 of the printed circuit board 15. Such a head 31 lies between the bar 28 and a fixing stud 33 which is inserted by force into the hole 18. The heat conduction between the electrically conductive track 25 and the heat sink 27 takes place by a physical contact between the fixing stud 33 and the conductive track 25, in particular on the outer periphery of the fixing stud 33.

The ventilation device 1 described in the variants above may comprise a plurality of holes 18 and/or a plurality of identical heat-conductive means 23 and/or a plurality of identical heat sinks 27.

According to another variant, the ventilation device 1 according to the present invention may comprise a combination of heat-conductive means 23 and/or heat sinks 27 produced according to at least two variants presented above.

The heat sink 27 according to any of the variants presented above is advantageously made of aluminum alloy.

1. A ventilation device of a ventilation unit of a passenger compartment of a motor vehicle, comprising:
an impeller generating an air flow and able to be driven by an electric motor; and
a printed circuit board on which at least one electronic component configured to release heat is attached, said printed circuit board comprising at least one through-hole provided in a part of said printed circuit board, the ventilation device being configured such that the air flow generated by the impeller passes over said part of the printed circuit board.

2. The ventilation device as claimed in claim 1, wherein the printed circuit board forms a control device able to control the electric motor.

3. The ventilation device as claimed in claim 1, wherein the printed circuit board is delimited by a first face on which at least the electronic component able to release heat is attached, and by a second face opposite the first face relative to said printed circuit board, said second face forming at least said part of the printed circuit board over which the air flow passes.

4. The ventilation device as claimed in claim 3, wherein a heat-conductive means extends into the hole.

5. The ventilation device as claimed in claim 4, wherein the heat-conductive means is formed by a metallized part of the hole.

6. The ventilation device as claimed in claim 5, wherein the heat-conductive means is in contact with an electrically conductive track which extends over the first face at least as far as the electronic component.

7. The ventilation device as claimed in claim 4, wherein an outer perimeter of the electronic component delimits a first region on the first face, the hole delimits a second region on the first face, the first region and the second region being separated by a distance not equal to zero.

8. The ventilation device as claimed in claim 4, wherein an outer perimeter of the electronic component delimits a first region on the first face, the hole delimits a second region on the first face, the first region and the second region overlapping at least partly.

9. The ventilation device as claimed in claim 4, wherein a heat sink is attached to the printed circuit board at the level of or in the hole, said heat sink opening from the second face so that the air flow passes over it.

10. The ventilation device as claimed in claim 9, wherein the heat sink comprises a head forming a support stop against the printed circuit board.

11. The ventilation device as claimed in claim 1, wherein the part of the printed circuit board over which the air flow passes carries at least a plurality of electrically conductive tracks configured to limit a risk of short-circuit.

12. The ventilation device as claimed in claim 1, wherein at least one wall is provided separating the printed circuit board into said part over which the air flow passes and a zone without such an air flow.

13. The ventilation device as claimed in claim 12, wherein the part of the printed circuit board over which the air flow passes carries no electronic components.

14. The ventilation device as claimed in claim 12, wherein at least one electronic component is attached to said zone.

15. A ventilation unit comprising a ventilation device as claimed in claim 1.
